(19) United States
(12) Patent Application Publication
(10) Pub. No.: US 2025/0031702 A1
(43) Pub. Date: Jan. 30, 2025

(54) STORAGE STABLE SOLUTION COMPRISING HYPOCHLOROUS ACID AND/OR HYPOCHLORITE

(71) Applicant: Zep, Inc., Atlanta, GA (US)

(72) Inventors: Daniel Herzog, Purkersdorf (AT); Philipp Kunze, Wien (AT)

(21) Appl. No.: 18/917,800

(22) Filed: Oct. 16, 2024

Related U.S. Application Data
(63) Continuation of application No. 17/668,356, filed on Feb. 9, 2022, now abandoned.

(51) Int. Cl. A01N 59/00; A01N 25/02; A01P 1/00

(52) U.S. Cl. CPC A01N 59/00; A01N 25/02; A01P 1/00

(57) ABSTRACT

A process for preparing a storage-stable aqueous solution comprising hypochlorous acid and/or hypochlorite includes introducing an aqueous NaCl solution into an electrolysis cell comprising a cathode compartment and an anode compartment separated by a membrane, wherein the aqueous NaCl solution is introduced into the cathode compartment via a first feed line and into the anode compartment via a second feed line, and wherein the aqueous NaCl solution comprises more than 100 ppm NaCl and has an electrical conductivity of less than 5 mS/cm, applying a direct current to a cathode in the cathode compartment and to an anode in the anode compartment to produce a cathode solution in the cathode compartment and an anode solution in the anode compartment, and mixing a portion of the cathode solution with the aqueous NaCl solution prior to its introduction into the anode compartment and/or with the anode solution in the anode compartment and/or with the anode solution in a discharge line associated with the anode compartment, to produce a storage-stable aqueous solution comprising hypochlorous acid and/or hypochlorite dischargeable via discharge line and has a pH value of 5 to 6.

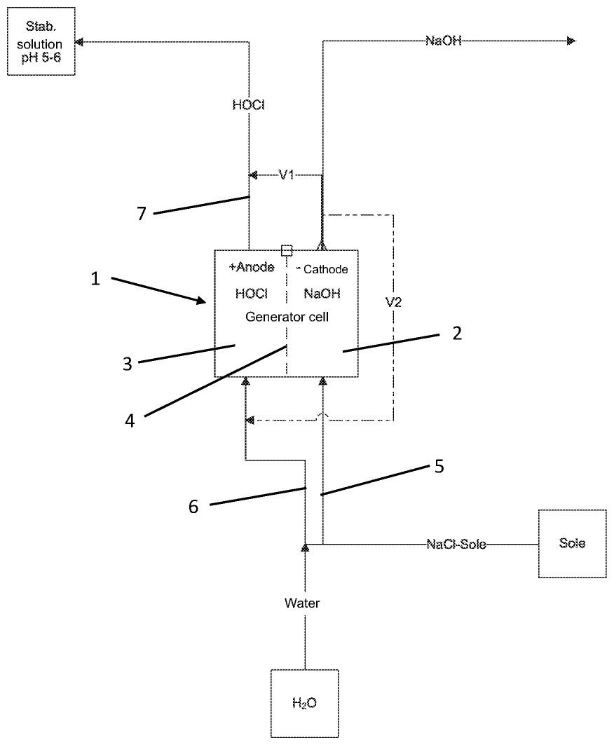

### CROSS-REFERENCE TO RELATED APPLICATIONS

This application is a continuation application of U.S. patent application Ser. No. 17/668,356, entitled “STORAGE STABLE SOLUTION COMPRISING HYPOCHLOROUS ACID AND/OR HYPOCHLORITE,” filed Feb. 9, 2022, which is incorporated herein by reference in its entirety.

### BACKGROUND OF THE INVENTION

The present invention relates to methods for preparing storage-stable aqueous solutions comprising hypochlorous acid and/or salts thereof.

Hypochlorous acid and/or salts thereof (hypochlorites) can be prepared by various methods. One commonly used process involves electrolysis of a NaCl solution, usually using electrolysis cells. Since explosive gas mixtures (oxygen and chlorine gas at the anode and hydrogen at the cathode) can arise during the electrolysis of NaCl solutions, there is a membrane or diaphragm in the electrolysis cell which separates the cell into an anode compartment and a cathode compartment. Only small ions such as sodium and hydroxide ions can pass through the membranes or diaphragms used in this process, so that there is no mixing of the solutions formed at the anode or cathode. Through this separation, an acidic, oxidizing solution with excellent disinfecting properties is formed in the anode compartment and a basic, reducing solution is produced in the cathode compartment. The solution produced in the anode compartment is called anolyte and the solution produced in the cathode compartment is called catholyte. The solutions prepared by this method are also known as electrochemically activated (ECA) solutions.

The antimicrobial activity of the anolyte solution is due to the interaction of the oxidative ions (hypochlorous acids), which have a relatively high redox potential, and the low pH. ECA solutions have been shown to kill 99.99% of germs and are over 100 times more effective than conventional chlorine bleach, for example. Thanks to their non-selective antimicrobial efficacy, they also do not contribute to the development of resistance. The effectiveness of ECA solutions against bacteria, fungi, viruses, algae and spores has been scientifically proven. This is why ECA solutions are used, among other things, in the treatment of drinking water and for the disinfection of e.g. medical equipment in hospitals. ECA solutions are also used in plant cultivation and animal husbandry. In certain countries, ECA solutions are al-so used in the production of food, whereby ECA solutions can come into direct or indirect contact with food.

In addition to their use as disinfectants, the use of ECA solutions for the treatment of wounds and burns has proven to be very effective, so that they have also proven themselves in the medical treatment of humans and animals.

The wide range of applications of ECA solutions in various fields demonstrates the usefulness of aqueous solutions comprising hypochlorous acid. However, it has been shown that the solutions produced with previous methods have a relatively low storage stability, so that the concentration of hypochlorous acid or hypochlorite in these solutions decreases significantly over time. Due to this decrease in concentration, the solution loses its effectiveness and can no longer be used for its intended purpose.

It is therefore an object of the present invention to provide a method which makes it possible to produce a storage-stable aqueous solution comprising hypochlorous acid and/or hypochlorite.

### SUMMARY OF THE INVENTION

Therefore, the present invention relates to a process for preparing a storage-stable aqueous solution comprising hypochlorous acid and/or hypochlorite comprising, in one or more embodiments, the steps of:
a. introducing an aqueous NaCl solution into an electrolysis cell comprising a cathode compartment and an anode compartment separated by a membrane, wherein the aqueous NaCl solution is introduced into the cathode compartment via a first feed line and into the anode compartment via a second feed line, and wherein the aqueous NaCl solution comprises more than 100 ppm NaCl and has an electrical conductivity of less than 5 mS/cm,
b. applying a direct current to a cathode in the cathode compartment and to an anode in the anode compartment to produce a cathode solution in the cathode compartment and an anode solution in the anode compartment, and
c. mixing a portion of the cathode solution
   with the aqueous NaCl solution prior to its introduction into the anode compartment and/or
   with the anode solution in the anode compartment and/or
   with the anode solution in a discharge line associated with the anode compartment,
to produce a storage-stable aqueous solution comprising hypochlorous acid and/or hypochlorite dischargeable via discharge line and has a pH value of 5 to 6.

Surprisingly, in an embodiment of the invention, electrolysis of a NaCl solution comprising more than 100 ppm NaCl and having an electrical conductivity of less than 5 mS/cm has been shown to allow the production of a storage stable solution comprising hypochlorous acid and/or hypochlorite, if the pH-value of the prepared solution is adjusted to 5 to 6.

In a further embodiment, particularly the pH of the solution prepared by the method of the invention, influences the stability of the hypochlorous acid and/or hypochlorite therein. The greatest stability was observed at a pH of 5 to 6. Therefore, the pH of the aqueous solution prepared in the electrolysis process according to an embodiment of the invention is adjusted to 5 to 6. The pH value can be adjusted in a variety of ways.

On the one hand, the pH value can be adjusted by introducing part of the cathode solution (catholyte) into the anode compartment. The catholyte, which is formed in the course of electrolysis, has a high pH value (more than 10) due to the formation of hydroxides. This high pH makes it possible to increase the pH of the anolyte in the anode compartment to 5 to 6. Without this feed, the pH of the anolyte would drop to below 4. The catholyte can be fed into the anolyte in a variety of ways, but it is particularly preferable to establish a connection between the cathode and anode compartments and to control the feed of the catholyte into the anode compartment via a valve, which is preferably pH-controlled. Corresponding devices are sufficiently described in the state of the art (see e.g. EP 1 074 515).

Alternatively, the catholyte can be brought into contact with the aqueous NaCl solution before it is introduced into the anode compartment. This is done, for example, by mixing part of the catholyte with the aqueous NaCl solution before introducing it into the anode compartment, which is then introduced into the anode compartment. In this way, the pH value of the anolyte is adjusted via the addition of the aqueous NaCl solution. The amount of catholyte that is brought into contact with the aqueous NaCl solution is preferably controlled by a valve that is coupled to a sensor that measures the pH of the storage-stable aqueous solution derived from the anode compartment according to an embodiment of the invention.

It has been shown according to an embodiment of the invention that it is also possible to adjust the pH of the storage-stable aqueous solution according to an embodiment of the invention by mixing the anolyte with a portion of the catholyte. In this case, a certain amount of catholyte is added to the anolyte, which is sufficient to adjust the pH of the derived anolyte to between 5 and 6. In addition to the catholyte, or alternatively, an aqueous solution containing NaOH or KOH can be added to the anolyte to adjust the pH of the final product to 5 to 6.

The anode and cathode preferably comprise or consist of metals such as titanium, the anode additionally comprising an electrocatalytically active layer (for the oxidation of chloride ions) containing metal oxides such as, for example, ruthenium oxide, iridium oxide, titanium oxide or mixtures thereof.

The anode chamber and the cathode chamber of the electrolysis cell used according to an embodiment of the invention are separated by a separator. The separator separates the solution in one chamber from the solution in the other chamber, allowing migration of selected ions between the chambers. Semi-permeable diaphragms or ion-selective membranes, for example, can be used as separators. The separators used may comprise a ceramic based on metal oxides, such as aluminum oxide, optionally containing further oxides such as zirconium oxide and yttrium oxide. Ion-selective membranes may, for example, comprise perfluorinated hydrocarbon, optionally containing ionic sulphonate groups. Known membranes are, for example, those made by DuPont (Wilmington, Delaware), sold under the trade name Nafion®.

At a pH value of over 7, an increased amount of chlorate is formed in solutions comprising hypochlorous acid and/or hypochlorite, which impairs the further stability of such solutions and which may lead to a toxic solution when higher concentrations of chlorate are present. Below pH 6, on the other hand, there is an increased formation of chlorine gas, which can be expelled from the solution, whereby the stability of the solution according to an embodiment of the invention is also negatively influenced.

Another aspect of the present invention relates to a storage-stable aqueous solution comprising hypochlorous acid and/or hypochlorite preparable by a process of the present invention.

### BRIEF DESCRIPTION OF THE DRAWING

The FIGURE is a schematic diagram showing a plant for producing the aqueous solution according to an embodiment of the present invention.

### DETAILED DESCRIPTION OF THE INVENTION

The process according to an embodiment of the invention can be used to prepare storage-stable aqueous solutions comprising hypochlorous acid and/or hypochlorite. “Storage stable” with respect to the aqueous solution according to an embodiment of the invention means that the concentration of the hypochlorous acid and/or hypochlorite decreases by a maximum of 10 to 30% after electrolysis in the solution over a longer period of time, for example, 2 to 6 months at room temperature (about 20° C.). It has been shown that the concentration of hypochlorous acid or hypochlorite in solutions prepared by conventional methods not according to the invention decreases by at least 50% within hours or days. Such solutions cannot be de-scribed as storage stable according to the invention. A sufficient storage stability of the solution according to the invention can be determined according to an embodiment of the invention in a “quick method” by determining its content of hypochlorous acid or hypochlorite after storage at a temperature of 54° C. If the content of hypochlorous acid or hypochlorite is not sufficient, the solution is stored at a temperature of 54° C. If the content of hypochlorous acid or hypochlorite after 14 days of storage is more than 50% of the initial value (measured immediately after its preparation), the solution is to be considered as storage stable.

Chlorine can occur in several forms when dissolved in water or aqueous solutions. The three different forms OCl—, HOCl and Cl2 are subsumed under the term “active chlorine”. The exact concentration of the individual forms of this free available chlorine (“FAC”) depends, among other things, on the pH value of the water or the aqueous solution and can be determined with the method ac-cording to DIN EN ISO 7939-1 as a “rapid method” (see e.g. https://echa.europa.eu/documents/10162/9c0ccb55-c2b2-8c43-9c93-26a758b6a058). This is a titrimetric method in which the freely available chlorine is brought into contact with N,N-diethyl-1,4-phenylenediamine (DPD), whereby a red compound is formed at a pH value of 6.2 to 6.5. Titration is carried out with a standard solution of ammonium iron(II) sulphate until the red color disappears.

During storage, the pH of the solutions prepared according to an embodiment of the invention may fall below 5. This has no influence on the storage stability as such, since it has been shown that the pH value im-mediately after the preparation of the solution according to an embodiment of the invention is decisive. At this point, it should range from 5 to 6. If the pH value is higher than 6 or lower than 5, this has a negative effect on the storage stability.

Storage stability has several advantages. Aqueous solutions comprising hypochlorous acid and/or hypochlorite, which are produced by conventional methods, have to be transported from the place of production to the place of use in a short time because of the low storage stability. Alternatively, the solutions are produced on site and used immediately afterwards. This means that a production plant is required at each place of use. With the method according to the invention, solutions are produced that are stable for months. This results in enormous logistical advantages and also opens up new areas of application (e.g. medical use for end consumers).

The electrolysis cell used according to an embodiment of the invention is operated with a voltage of 5 to 40 volts, preferably 10 to 30 volts, and a current of 40 to 80 amperes, preferably 45 to 75 amperes. It has been shown that the formation of hypochlorous acid or hypochlorite proceeds particularly well in these ranges.

The FIGURE shows the schematic structure of a plant suitable for producing the aqueous solution according to an embodiment of the invention. First, water is mixed with a preferably saturated NaCl solution and introduced into the cathode chamber 2 or anode chamber 3 of the electrolysis cell 1 via lines 5 and 6. The anolyte, from which the solution according to an embodiment of the invention is obtained and which comprises hypochlorous acid or hypochlorite, is removed from the anode chamber via discharge line 7. V1 and V2 represent conduits by which catholyte can be fed from the cathode chamber either in-to line 7 and/or into feed conduit 6 to adjust the pH of the anolyte.

According to a preferred embodiment of the present invention, the aqueous NaCl solution has an electrical conductivity of from 1 to 5 mS/cm, preferably from 1.5 to 4.5 mS/cm, more preferably from 2 to 4 mS/cm, even more preferably from 2.5 to 4 mS/cm.

The stability of hypochlorous acid or hypochlorite in an aqueous solution depends on the electrical conductivity. The higher this conductivity, the more unstable the solution is with respect to hypochlorous acid or hypochlorite. The lowest range of electrical conductivity is defined by the minimum concentration of 100 ppm NaCl in the solution to be electrolyzed.

The electrical conductivity is measured with known procedures (as according to ISO 7888) at a temperature of approx. 22° C.

According to another preferred embodiment of the present invention, the aqueous NaCl solution comprises from 200 to 2000 ppm, preferably from 300 to 1500 ppm, even more preferably from 300 to 1000 ppm, even more preferably from 300 to 700 ppm, NaCl.

The NaCl solution used for electrolysis and introduced into the anode and cathode chambers preferably comprises 200 to 2000 ppm NaCl. The relatively small amount of NaCl in the electrolysis solution has the advantage that the solution according to the invention produced with it, comprising hypochlorite or hypochlorous acid, is also low in NaCl. This is particularly advantageous with regard to the corrosiveness of the solution to, for example, iron or iron-containing objects. It has been shown that the solution produced according to an embodiment of the invention has a significantly lower corrosiveness than comparable solutions from the prior art that were produced using other methods.

According to a preferred embodiment of the present invention, the aqueous NaCl solution has an exhaust vapor residue of 1200 to 2000 mg/l, preferably of 1300 to 1900 mg/l, even more preferably of 1400 to 1800 mg/l.

The evaporation residue, which can be determined by evaporating (i.e. removing the volatile compounds such as water) one liter of the aqueous NaCl solution, indicates the amount of non-volatile compounds, such as salts, in the solution. Since the stability of the aqueous solution according to an embodiment of the invention can be influenced by the amount of ions present, the evaporation residue in the aqueous NaCl solution should ideally not exceed a certain concentration.

According to a particularly preferred embodiment of the present invention, the aqueous NaCl solution is prepared by mixing a saturated aqueous NaCl solution and water, wherein the water has a conductivity of less than 2 mS/cm, preferably less than 1.5 mS/cm, even more preferably less than 1 mS/cm.

The NaCl solution introduced into the electrolysis cell is preferably prepared by mixing a saturated aqueous NaCl solution and water. The water used should also have a low electrical conductivity to prevent the total conductivity from exceeding 5 mS/cm. In a particularly preferred embodiment, the water used in this process may be deionized or distilled.

According to a preferred embodiment of the present invention, the water used to prepare the aqueous NaCl solution from a saturated NaCl solution has an electrical conductivity between 0.1 and 2 mS/cm, preferably between 0.2 and 1.5 mS/cm, more preferably between 0.4 and 1 mS/cm.

According to another preferred embodiment of the present invention, the water has an exhaust residue of from 5 to 500 mg/l, preferably from 5 to 300 mg/l, even more preferably from 10 to 250 mg/l.

According to a preferred embodiment of the present invention, the aqueous NaCl solution and/or the water has a pH of from 6.8 to 9.5, preferably from 7 to 9.2.

According to a particularly preferred embodiment of the present invention, the aqueous NaCl solution and/or the water has a carbonate concentration, i.e. concentration of HCO3-, of from 10 to 500 ppm, preferably from 20 to 400 ppm, even more preferably from 30 to 300 ppm, even more preferably from 40 to 250 ppm.

Surprisingly, it has been shown that the carbonate hardness (expressed as concentration of HCO3-) of the aqueous NaCl solution introduced into the anode or cathode compartment, or of the water with which the aqueous NaCl solution is prepared, can have an influence on the stability of the aqueous solution according to an embodiment of the invention. The carbonate hardness (KH) is the proportion of alkaline earth ions bound to carbonates (CO32-) and hydrogen carbonates (HCO3-) and dissolved in the water.

According to a preferred embodiment of the present invention, the aqueous NaCl solution comprises less than 0.3 ppm, preferably less than 0.2 ppm, of copper ions, nickel ions and/or iron ions.

The stability of hypochlorous acid or hypochlorite in aqueous solutions is also influenced by the content of metal ions, especially the content of copper ions, nickel ions and iron ions. If their concentration is below certain limit values, the storage stability of the aqueous solutions produced according to the invention is further increased.

According to a preferred embodiment of the present invention, the aqueous NaCl solution comprises less than 0.02 ppm, preferably less than 0.01 ppm, nitrate ions and/or nitrate ions.

It is advantageous if the aqueous NaCl solution has a low content of nitrate ions and/or nitrate ions in order to obtain a stable electrolysis product.

According to a further preferred embodiment of the present invention, the aqueous NaCl solution comprises less than 500 ppm, preferably less than 400 ppm, even more preferably less than 300 ppm, of sulphate ions, phosphate ions and/or silicate ions.

The stability of the aqueous solution according to an embodiment of the invention can be further increased if the aqueous NaCl solution comprises less than 500 ppm of sulphate ions, phosphate ions and/or silicate ions.

According to a still further preferred embodiment of the present invention, the aqueous NaCl solution comprises less than 50 ppm, preferably less than 40 ppm, even more preferably less than 30 ppm, even more preferably less than 20 ppm, calcium ions and/or magnesium ions.

It has been shown that too high a concentration of calcium or magnesium ions in the aqueous NaCl solution can lead to a product which has a lower stability.

According to a particularly preferred embodiment of the present invention, the aqueous NaCl solution comprises 20 to 200 ppm, preferably 50 to 100 ppm, of an inorganic buffer.

Surprisingly, it has been shown that the addition of an inorganic buffer substance to the NaCl solution used has a positive influence on the storage stability of the solution according to an embodiment of the invention and increases it even further.

According to a further preferred embodiment of the present invention, the inorganic buffer comprises hydrogen carbonate. Preferably, 10 to 500 ppm, preferably 20 to 400 ppm, even more preferably 30 to 300 ppm, even more preferably 40 to 250 ppm, of carbonations in the form of e.g. sodium hydrogen carbonate is added to the electrolysis solution.

In particular, the use of carbonates, such as hydrogen carbonates, showed positive effects on the storage stability, where-by sodium hydrogen carbonate is preferably used.

According to a particularly preferred embodiment of the present invention, the aqueous NaCl solution is introduced into the electrolysis cell and the storage-stable aqueous solution is discharged from the electrolysis cell at a flow velocity of 0.1 m/s to 1 m/s, preferably 0.2 m/s to 0.9m/s.

The flow rate selected in the electrolysis process according to an embodiment of the invention additionally influences the stability of the aqueous solution produced. That is, if a certain flow rate is select-ed at which the electrolysis is carried out, this can result in an even more stable product that has a lower degradation rate of the hypochlorous acid or hypochlorite.

The electrolysis cell is preferably brought to a temperature of from 2° C. to 20° C., even more preferably from COC to 15° C., even more preferably from 5° C. to 10° C., during the process according to an embodiment of the invention.

Cooling the electrolysis cell and thus the anolyte or catholyte therein also results in a more stable final product and a lower chlorate concentration in the manufactured product. Alternatively or additionally, the salt solution supplied to the cathode and anode compartment may be brought to a temperature of from 2° C. to 20° C., more preferably from 3° C. to 15° C., even more preferably from 5° C. to 10° C., prior to its introduction. By continuously feeding cooled salt solution, the temperature in the electrolysis cell can be reduced accordingly. Thus, it would also be possible to dispense with cooling the electrolysis cell.

Another aspect of the present invention relates to a storage-stable aqueous solution preparable by a process according to an embodiment of the invention.

According to a preferred embodiment of the present invention, the storage stable solution has an electrical conductivity of less than 4 mS/cm, preferably less than 3 mS/cm, more preferably less than 2.5 mS/cm.

According to another preferred embodiment of the present invention, the storage stable solution has an electrical conductivity of from 0.5 to 4 mS/cm, preferably from 1 to 3 mS/cm, even more preferably from 1.2 to 3 mS/cm, even more preferably from 1.4 to 2.5 mS/cm.

The conductivity of the storage-stable solution is usually lower than that of the aqueous NaCl solution introduced into the anode or cathode chamber. During electrolysis, chlorine, among other things, is formed in the anode chamber from the chloride ions, which is expelled from the anolyte during electrolysis. Ions are thus removed from the system.

According to a still further preferred embodiment of the present invention, the storage stable solution comprises between 50 and 1500 ppm, preferably between 100 and 1000, even more preferably between 150 and 800, even more preferably between 200 and 600 ppm, hypochlorous acid and/or hypochlorite.

With the process according to an embodiment of the invention it is possible to prepare a stable aqueous solution comprising between 50 and 1500 ppm hypochlorous acid and/or hypochlorite.

According to a further preferred embodiment of the present invention, the ratio between hypochlorous acid and/or hypochlorite and chloride ions in the storage-stable solution is 1:1.2 to 1:2.8, preferably 1:1 to 1:1.5 to 1:2.5, more preferably 1:1.7 to 1:2.1.

The process according to an embodiment of the invention produces a storage-stable solution which preferably has these ratios between hypochlorous acid and/or hypochlorite and chloride ions. In the course of storage of the solution, this ratio may change over time due to degradation of the hypochlorous acid or hypochlorite, but it is crucial that this ratio prevails immediately after electrolysis. This ratio also has a positive effect on storage stability.

According to a particularly preferred embodiment of the present invention, the storage-stable aqueous solution comprises chlorate at a concentration of less than 50 ppm, preferably less than 40 ppm, even more preferably less than 30 ppm, even more preferably less than 25 ppm, even more preferably less than 20 ppm.

In solution, hypochlorous acid or hypochlorite disproportionates over time to chlorate and chloride. Due to the measures taken in the preparation of the aqueous solution according to the invention, the concentration of chlorate is relatively low compared to solutions prepared by conventional methods, where degradation of the hypochlorous acid or hypochlorite occurs rapidly. Chlorate has toxic effects in high concentrations, which would limit its therapeutic use, for example. The solution according to an embodiment of the invention always has a chlorate content of less than 50 ppm after preparation and also during storage.

For the shelf life of the solution according to an embodiment of the invention, it has been shown that a quantity ratio of chlorate to FAC of less than 3.5 during preparation or immediately thereafter is particularly advantageous, since hypochlorous acid or hypochlorite is degraded least at this ratio.

According to a preferred embodiment of the present invention, the storage-stable aqueous solution has a pH of 4 to 6.

Immediately after preparation of the solution according to an embodiment of the invention, the pH of the solution may drop. Surprisingly, it has been shown that the initial pH value immediately after preparation is important for storage stability.

According to a particularly preferred embodiment of the present invention, the storage stable aqueous solution comprises less than 0.3 ppm, preferably less than 0.2 ppm, of copper ions, nickel ions and/or iron ions.

According to a preferred embodiment of the present invention, the storage-stable aqueous solution comprises less than 0.1 ppm, preferably less than 0.05 ppm, even more preferably less than 0.01 ppm, nitrate ions and/or nitrite ions.

According to another preferred embodiment of the present invention, the storage-stable aqueous solution comprises less than 500 ppm, preferably less than 400 ppm, even more preferably less than 300 ppm, sulphate ions, phosphate ions and/or orthosilicate ions.

According to a particularly preferred embodiment of the present invention, the storage-stable aqueous solution comprises less than 50 ppm, preferably less than 40 ppm, even more preferably less than 30 ppm, even more preferably less than 20 ppm, calcium ions and/or magnesium ions.

According to a preferred embodiment of the present invention, the storage-stable aqueous solution has a redox potential of from 1,000 to 1,500 mV, preferably from 1,100 to 1,400 mV, more preferably from 1,150 to 1,300 mV.

According to a particularly preferred embodiment of the present invention, the storage-stable aqueous solution has an evaporation residue of from 200 to 1500 mg/l, preferably from 500 to 1250 mg/l, even more preferably from 600 to 1,200 mg/l.

The stable solution according to an embodiment of the invention can be used for all purposes as known solutions comprising hypochlorous acid and hypochlorite, in particular as disinfectant, for water disinfection, wound disinfection, wound healing, plant cultivation, and the like.

### EXAMPLES

### Materials and Methods

### Determination of the Storage Stability

In order to be able to test the long-term stability or storage stability of a product in an accelerated procedure, normal long-term ageing is simulated by heating the product over a certain period of time. This test provides reliable data on the long-term stability of a product. To perform the test, a product sample is placed in a glass bottle, then sealed and heated at a constant temperature for a defined time in a heating cabinet. In these examples, the determination of storage stability was carried out according to the CIPAC MT46.3 procedure (CIPAC; Collaborative International Pesticides Analytical Council).

In the following examples, in which the influence of different parameters on the stability of hypochlorous acid or hypochlorite was investigated, approx. 500 ml of the respective samples were each placed in a glass bottle, which was then closed with a lid with a polyethylene insert. The sealed glass bottles were placed in an oven at a temperature of 54° C. (+/−2° C.) for a maximum of 14 days. At the beginning, i.e. before filling the samples into the bottles, after 2 days, after 7 days and after 14 days, the glass bottles were removed from the oven and allowed to cool down to room temperature. Subsequently, the aged solutions from the glass bottles were examined.

### Determination of the Freely Available Chlorine

The concentration of the freely available chlorine in the samples was determined using the procedure according to DIN EN ISO 7939-1. The pH value of the sample solutions was adjusted to approx. 6.2 to 6.5 and N,N-diethyl-1,4-phenylenediamine (DPD) was added. The addition of DPD caused the sample solution to turn red. The content of freely available chlorine was determined by subsequent titration with a standard solution of ammonium iron(II) sulphate until the red color disappeared.

The content of freely available chlorine was determined by multiplication with the factor 0.74 into the content of hypochlorous acid or hypochlorite.

### Example 1: Influence of the pH Value on the Storage Stability of the Aqueous Solution According to an Embodiment of the Invention

In order to investigate the influence of the pH value on the storage stability of the aqueous solution comprising hypochlorous acid or hypochlorite, solutions were prepared using the method according to an embodiment of the invention. The pH of the solutions was adjusted to 4, 5, 6, 7 and 7.4 by adding the cathode solution to the anode solution. These solutions were subjected to the ageing procedure described above. The temperature of the solutions in the gas flasks was kept constant at 54° C. and the concentrations of freely available chlorine and thus of hypochlorous acid or hypochlorite were determined before the ageing process, after 2, 7 and 14 days. Distilled water was used in each step of the process to prepare the solutions comprising hypochlorous acid or hypochlorite. Electrolysis was carried out at 20 volts and 60 amperes direct current. The flow velocity was 0.8 m/s. The following table lists the measured values:

TABLE A

| | pH 4 | | pH 5 | | pH 6 | | pH 7 | | pH 7, 4 | |
|---|---|---|---|---|---|---|---|---|---|---|
| | Cl₂ | ΔFAC | Cl₂ | ΔFAC | Cl₂ | ΔFAC | Cl₂ | ΔFAC | Cl₂ | ΔFAC |
| Day | [ppm] | [%] | [ppm] | [%] | [ppm] | [%] | [ppm] | [%] | [ppm] | [%] |
| 0 | 539 | 100 | 537 | 100 | 550.5 | 100 | 504 | 100 | 496 | 100 |
| 2 | 450 | 83 | 530 | 98.7 | 491.5 | 89 | 364.5 | 72 | 350 | 71 |
| 7 | 420 | 78 | 470 | 88.0 | 450.5 | 81 | 271.5 | 54 | 230 | 46 |
| 14 | 370 | 69 | 400 | 74.5 | 442.5 | 80 | 232 | 46 | 169.5 | 34 |

Table A clearly shows that by adjusting the pH value to pH 5 to 6, a significantly higher storage stability can be achieved with regard to the degradation of hypochlorous acid or hypochlorite. The adjustment of the pH value is essential to enable the production of a storage-stable aqueous solution.

In addition to the free available chloride (FAC) content, the chlorate content was measured according to ISO 10304-4. Surprisingly, this was found to be below 50 ppm for all samples at pH 5 and 6. By day 7, the chlorate content at pH 5 and 6 was even less than 20 ppm. In contrast, in the samples with pH 7 and 7.4, a chlorate content of at least 50 ppm was determined by ion chromatography from day 0 and 2.

### Example 2: Influence of the Carbonate Hardness on the Storage Stability of the Aqueous Solution

The carbonate hardness, expressed in terms of the concentration of HCO3- present, of the water used in the process or of the NaCl solution used can also influence the storage stability of the solution produced by the process of the invention with regard to the degradation of the hypochlorous acid or hypochlorite. Therefore, distilled water comprising different concentrations of HCO3- (added in the form of sodium hydrogen carbonate) was used to prepare the electrolysis solution containing NaCl. The pH of the prepared aqueous solution was adjusted to about 6.5 as de-scribed in Example 1. The solution prepared by electrolysis was subjected to an accelerated ageing process as described in Example 1. The temperature was kept constant at 54° C. during the stability test. FAC measurements were carried out after 0 and 14 days.

TABLE B

| HCO₃_{^{−}} [ppm] | ΔFAC [%] |
|---|---|
| 0 | 0.36 |
| 50 | 0.26 |
| 100 | 0.31 |
| 250 | 0.38 |
| 500 | 0.67 |

Table B shows the change in FAC expressed in % after 2 weeks storage at 54° C. as described above. The results show that the amount of HCO3- present can influence the storage stability of the solutions prepared according to an embodiment of the invention, whereby the stability can be further increased if necessary.

### Example 3: Influence of Various Anions and Cations on the Storage Stability of the Aqueous Solution

To investigate the influence of various anions and cations on the storage stability of an aqueous solution produced by electrolysis according to an embodiment of the invention, electrolysis solutions with different concentrations of copper, nickel, iron, calcium, magnesium, nitrate, nitrite, sulphate, phosphate and ortho ions were prepared. For this purpose, distilled water was mixed with NaCl and with different concentrations of the ions mentioned here in the form of chloride or sodium salts and then introduced into the anode and cathode compartment of an electrolysis cell and subjected to electrolysis as described in Example 1. The resulting aqueous solutions, which had a pH of about 6, were subjected to an accelerated ageing process as described in Example 1. The temperature was kept constant at 54° C. and after 14 days, change in FAC present with respect to a product according to Example 1 with pH 6 and was compared (“reference”).

TABLE C

| | | |
|---|---|---|
| Anion/Cation | Concentration | Evaluation |

| | | | |
|---|---|---|---|
| NO₃₋ | 5 | ppb | n |
| NO₃₋ | 20 | ppb | j |
| NO₃₋ | 50 | ppb | j |
| NO₂₋/NO₃₋ | 10/10 | ppb | j |
| NO₂₋/ | 5 | ppb | n |
| Fe³⁺ | 150 | ppb | n |
| Fe³⁺ | 250 | ppb | j |
| Ni²⁺ | 500 | ppb | j |
| Cu²⁺ | 100 | ppb | n |
| Cu²⁺ | 500 | ppb | j |
| Cu²⁺/Fe | 50/50 | ppb | n |
| Cu²⁺/Fe/Ni²⁺ | 50/50/50 | ppb | n |
| Ni²⁺ | 100 | ppb | n |
| SO₄²⁻ | 200 | ppm | n |
| SO₄²⁻ | 450 | ppm | j |
| PO₄²⁻ | 200 | ppm | n |
| SiO₄²⁻ | 100 | ppm | n |
| SiO₄²⁻ | 500 | ppm | j |
| SiO₄²⁻/SO₄²⁻/ | 100/100/100 | ppm | n |
| PO₄²⁻ | | | |
| SiO₄²⁻/SO₄²⁻/ | 200/250/300 | ppm | j |
| PO₄²⁻ | | | |
| Ca²⁺ | 10 | ppm | n |
| Ca²⁺ | 20 | ppm | n |
| Ca²⁺ | 40 | ppm | j |
| Mg²⁺ | 10 | ppm | n |
| Mg²⁺ | 20 | ppm | n |
| Mg²⁺ | 40 | ppm | j |
| Ca²⁺/Mg²⁺ | 10/5 | ppm | n |
| Ca²⁺/Mg²⁺ | 20/5 | ppm | n |
| Ca^{2+/}Mg²⁺ | 20/10 | ppm | j |

n . . . no or +/−10% FAC-change compared to reference
j . . . decrease of FAC >10% compared to reference

### Example 4: Influence of the Flow Rate on the Storage Stability of the Aqueous Solution

During electrolysis to produce the solutions according to the invention, the salt solution is introduced into the anode and cathode chambers at a certain flow rate. At the same flow rate, the aqueous solution of the invention comprising hypochlorous acid or hypochlorite is recovered from the anode chamber. To investigate the influence of the flow rate during electrolysis on the storage stability of the electrolysis product, electrolysis was carried out at different flow rates as described in Example 1. The electrolysis products were subjected to an accelerated ageing process as described in Example 1. The flow rates of introduction and discharge of the storage-stable aqueous solution into and out of the electrolysis cell varied between 0.61 m/s and 0.88 m/s. The temperature at which the storage-stable aqueous solution was introduced and discharged varied between 0.61 m/s and 0.88 m/s. The temperature during the stability test was kept constant at 54° C. and the content of FAC and chlorate was determined after 0 and 14 days. Distilled water was used to prepare the electrolysis solutions.

TABLE D

| | | | | | Delta | | Chlorate |
|---|---|---|---|---|---|---|---|
| | | | | Ratio | FAC | | after |
| | | | FAC | ClO3/ | 52° C./ | Delta | 14 d/ |
| Sample | m/s | pH | [ppm] | FAC | 14 d | Chlorate | 54° C. |
| pH5-1 | 0.61 | 5 | 499 | 0.04 | 0.28 | 1.544 | 31 |
| pH5-2 | 0.79 | 5 | 511 | 0.034 | 0.25 | 1.65714 | 29 |
| pH5-3 | 0.88 | 5 | 488 | 0.028 | 0.23 | 1.88406 | 26 |
| pH6-1 | 0.61 | 6 | 526 | 0.042 | 0.37 | 1.72727 | 38 |
| pH6-2 | 0.79 | 6 | 517 | 0.033 | 0.32 | 1.90751 | 33 |
| pH6-3 | 0.88 | 6 | 504 | 0.031 | 0.29 | 1.81818 | 28 |
| pH7-1 | 0.61 | 7 | 476 | 0.062 | 0.54 | 4.91422 | 145 |
| PH7-2 | 0.79 | 7 | 477 | 0.05 | 0.5 | 5.71225 | 135 |
| pH7-3 | 0.88 | 7 | 480 | 0.04 | 0.47 | 6.31579 | 120 |

Table D shows that the flow rate has an additional influence on the storage stability of the electrolysis product. It was shown that increasing the flow rate leads to a more stable product with a lower chlorate concentration.

Various embodiments of the invention have been described. It will, however, be evident that various modifications and changes may be made thereto, and additional embodiments may be implemented, without departing from the broader scope of the invention as set forth by the claims. This specification is to be regarded in an illustrative rather than a restrictive sense.

What is claimed is:

1. A process for preparing a storage-stable aqueous solution comprising hypochlorous acid and/or hypochlorite comprising the steps of:
introducing an aqueous NaCl solution into an electrolysis cell comprising a cathode compartment and an anode compartment separated by a separator, wherein the aqueous NaCl solution is introduced into the cathode compartment via a first feed line and into the anode compartment via a second feed line, and wherein the aqueous NaCl solution comprises more than 100 ppm NaCl and has an electrical conductivity of less than 5 mS/cm,
applying a direct current to a cathode in the cathode compartment and to an anode in the anode compartment to produce a cathode solution in the cathode compartment and an anode solution in the anode compartment,
mixing a portion of the cathode solution with (i) the aqueous NaCl solution prior to its introduction into the anode compartment and/or (ii) with the anode solution in the anode compartment and/or (iii) with the anode solution in a discharge line associated with the anode compartment, and
producing a dischargeable storage-stable aqueous solution comprising hypochlorous acid and/or hypochlorite having a pH value of from 5 to 6,
wherein the storage-stable aqueous solution comprises chlorate at a concentration of less than 50 ppm and hypochlorous acid and/or hypochlorite at a concentration between 50 and 1500 ppm,
wherein the storage-stable aqueous solution has an electrical conductivity of from 1 to 4 mS/cm, and
wherein the storage-stable aqueous solution has a molar ratio between (i) hypochlorous acid and/or hypochlorite and (ii) chloride ions from 1:1.2 to 1:2.8.

2. The process according to claim 1, wherein the aqueous NaCl solution has an electrical conductivity of from 1 to 5 mS/cm.

3. The process according to claim 1, wherein the aqueous NaCl solution comprises from 200 to 2000 ppm of NaCl.

4. The process according to claim 1, wherein the aqueous NaCl solution has an evaporation residue of from 1200 to 2000 mg/l.

5. The process according to claim 1, wherein the aqueous NaCl solution is prepared by mixing a saturated aqueous NaCl solution and water, the water having a conductivity of less than 2 mS/cm.

6. The process according to claim 5, wherein the water has an electrical conductivity of between 0.1 and 2 mS/cm.

7. The process according to claim 5, wherein the water has an evaporation residue of from 5 to 500 mg/l.

8. The process according to claim 1, wherein the aqueous NaCl solution and/or the water has a pH of from 6.8 to 9.5.

9. The process according to claim 1, wherein the aqueous NaCl solution and/or the water has 10 to 500 ppm of carbonate ions.

10. The process according to claim 1, wherein in the the aqueous NaCl solution comprises less than 0.3 ppm of copper ions, nickel ions, and/or iron ions.

11. The process according to claim 1, wherein the aqueous NaCl solution comprises less than 0.1 ppm nitrate ions and/or nitrite ions.

12. The process according to claim 1, wherein the aqueous NaCl solution comprises less than 500 ppm sulphate ions, phosphate ions and/or silicate ions.

13. The process according to claim 1, wherein the aqueous NaCl solution comprises less than 50 ppm calcium ions and/or magnesium ions.

14. The process according to claim 1, wherein the aqueous NaCl solution comprises 20 to 200 ppm of an inorganic buffer.

15. The process according to claim 14, wherein the inorganic buffer comprises hydrogen carbonate.

16. The process according to claim 1, further comprising introducing the aqueous NaCl solution into the electrolysis cell and discharging the storage-stable aqueous solution from the electrolysis cell takes place at a flow rate of from 0.1 m/s to 1 m/s.

17. The process according to according to claim 1, further comprising bringing the electrolysis cell to a temperature of from 2° C. to 20° C.
